(19) United States
(12) Patent Application Publication
(10) Pub. No.: US 2024/0170864 A1
(43) Pub. Date: May 23, 2024

(54) PLUG CONNECTOR COUPLED TO RECEPTACLE CONNECTOR

(71) Applicants: SENSORVIEW CO., LTD., Seongnam-si (KR); OKINS ELECTRONICS CO., LTD, Uiwang-si (KR)

(72) Inventors: Byoung Nam KIM, Bucheon-si (KR); Kyoung Il KANG, Suwon-si (KR); Joung Min PARK, Osan-si (KR); Sung Cheol CHO, Hwaseong-si (KR); Jin Kook JUN, Gunpo-si (KR); Sung Gyu PARK, Anyang-si (KR); Soeung Chel JANG, Suwon-si (KR)

(73) Assignees: SENSORVIEW CO., LTD., Seongnam-si, GG (KR); OKINS ELECTRONICS CO., LTD, Uiwang-si, GG (KR)

(21) Appl. No.: 18/552,037

(22) PCT Filed: Mar. 3, 2022
(86) PCT No.: PCT/KR2022/002974

§ 371 Date: Sep. 22, 2023

(30) Foreign Application Priority Data
Mar. 25, 2021 (KR) 10-2021-0038871

(51) Int. Cl. H01R 9/05; H01R 24/40; H01R 103/00

(52) U.S. Cl. CPC H01R 9/0524; H01R 24/40; H01R 2103/00

(57) ABSTRACT

A plug connector coupled to a receptacle connector is presented, comprising: a conductor for signals; a ring-shaped conductor for ground, the conductor for ground surrounding the conductor for signals; a ring-shaped insulator surrounding the conductor for signals and being surrounded by the conductor for ground, and insulating between the conductor for signals and the conductor for ground; a lower body; and an upper body coupled onto the lower body. The conductor for signals includes a lower portion protruding below a first portion of the top of the insulator, a middle portion inserted into a hollow portion of the first portion, and an upper portion protruding above the first portion. The conductor for ground includes a lower portion protruding below the first portion and an upper portion surrounding the first portion. The lower body includes a lower housing, such that the upper portion is accommodated in the hollow portion.

### TECHNICAL FIELD

The present invention relates to a connector, and more particularly, to a plug connector coupled to a receptacle connector.

### BACKGROUND ART

Various types of electronic devices (e.g., wired/wireless communication devices) include a circuit board. A connector assembly including a receptacle connector and a plug connector is used to connect the circuit board to other electronic devices or other circuit boards. The receptacle connector is mounted on the circuit board, the plug connector is coupled to a cable, and the plug connector is connected to the receptacle connector, so that the cable and the circuit board are electrically connected.

Conventionally, a structure for grounding has been utilized, where a conductor for ground provided on the outer circumference of a dielectric surrounding a signal line of a cable is electrically connected through soldering to a housing of a plug connector formed with a conductive material. However, when connecting the conductor for ground of the cable and the housing through soldering in this way, there were issues such as cable damage and functional degradation due to heat at the soldered portion, and failure to sturdily support the conductor for ground of the cable. Also, there were problems with the soldered portion being damaged by cable movement, external shocks, etc., and with the conductor for ground of the cable being easily separated from the housing.

### DETAILED DESCRIPTION OF THE INVENTION

### Technical Problem

An object of the present invention is to provide a plug connector which allows electrical and physical connection between a grounding conductor of a cable and a conductive housing of the plug connector to be achieved by clamping without the use of soldering, thereby increasing electrical and physical stability and improving shielding performance.

The objects to be achieved by the present invention are not limited to the foregoing object, and additional objects, which are not mentioned herein, will be readily understood by those skilled in the art from the following description.

### Technical Solution

A plug connector according to the present invention for solving the above technical problem is a plug connector coupled to a receptacle connector, the plug connector including: a conductor for signals; a ring-shaped conductor for ground, the conductor for ground surrounding the conductor for signals; a ring-shaped insulator surrounding the conductor for signals and being surrounded by the conductor for ground, and insulating between the conductor for signals and the conductor for ground; a lower body; and an upper body coupled onto the lower body, wherein: the conductor for signals includes a lower portion protruding below a first portion of the top of the insulator, a middle portion inserted into a hollow portion of the first portion, and an upper portion protruding above the first portion; the conductor for ground includes a lower portion protruding below the first portion and an upper portion surrounding the first portion; the lower body includes a lower housing having a hollow portion that is vertically opened, such that the upper portion of the conductor for ground is accommodated in the hollow portion and the lower portion of the conductor for ground and the lower portion of the conductor for signals are exposed downwards, and a lower clamping portion having a part surrounding an exposed outer conductor of the cable and another part surrounding a sheath of the cable; the upper body includes an upper housing facing the lower housing and having a hollow portion opened downwards such that the hollow portion forms a space around the upper portion of the conductor for signals, and an upper clamping portion having a part surrounding the exposed outer conductor of the cable and another part surrounding the sheath of the cable; and the cable is clamped by the lower clamping portion and the upper clamping portion.

The plug connector may further include a clamp ring configured to compress the lower clamping portion and the upper clamping portion, enabling the lower clamping portion and the upper clamping portion to clamp the cable.

The lower body may further include a lower guide portion configured to guide the cable toward the conductor for signals from one side of the lower housing, the lower clamping portion may protrude from one side of the lower guide portion, the upper body may further include an upper guide portion facing the lower guide portion and configured to guide the cable toward the conductor for signals from one side of the upper housing, and the upper clamping portion may protrude from one side of the upper guide portion.

The upper portion of the conductor for signals may be coupled to a signal line of the cable through soldering.

An end of a signal line of the cable may be located above the upper portion of the conductor for signals.

A protruding portion may be formed along a circumference of an outer circumferential surface of the clamp ring, protruding in a radial direction, a radially concave portion that overlaps the protruding portion in a radial direction may be formed along a circumference of an outer circumferential surface of the lower clamping portion, and a radially concave portion that overlaps the protruding portion in a radial direction may be formed along a circumference of an outer circumferential surface of the upper clamping portion.

Concave portions that are radially concave may be formed on both sides of the protruding portion along the circumference of the outer circumferential surface of the clamp ring.

The protruding portion may include first and second protruding portions, and a radially concave portion may be formed between the first and second protruding portions.

On an inner circumferential surface of the lower clamping portion, specifically a portion that wraps around the exposed outer conductor of the cable, a protruding portion may formed along a circumference, protruding in a radial direction, and on an inner circumferential surface of the upper clamping portion, specifically a portion that wraps around the exposed outer conductor of the cable, a protruding portion may be formed along a circumference, protruding in a radial direction.

On an inner circumferential surface of the lower clamping portion, specifically a portion that wraps around the sheath of the cable, a protruding portion may be formed along a circumference, protruding in a radial direction, and on an inner circumferential surface of the upper clamping portion, specifically a portion that wraps around the sheath of the cable, a protruding portion may be formed along a circumference, protruding in a radial direction.

A second portion of a lower portion of the insulator may be surrounded by the lower portion of the conductor for ground while surrounding the lower portion of the conductor for signals.

The lower body and the upper body may be formed of a conductive material.

A plug connector according to the present invention for solving the above technical problem is a plug connector coupled to a receptacle connector, the plug connector including: a conductor for signals; a ring-shaped conductor for ground, the conductor for ground surrounding the conductor for signals; a ring-shaped insulator surrounding the conductor for signals and being surrounded by the conductor for ground, and insulating between the conductor for signals and the conductor for ground; a lower body; and an upper body coupled onto the lower body, wherein: the conductor for signals includes a lower portion protruding below a first portion of the top of the insulator, a middle portion inserted into a hollow portion of the first portion, and an upper portion protruding above the first portion; the conductor for ground includes a lower portion protruding below the first portion and an upper portion surrounding the first portion; the lower body includes a lower housing having a hollow portion that is vertically opened, such that the upper portion of the conductor for ground is accommodated in the hollow portion and the lower portion of the conductor for ground and the lower portion of the conductor for signals are exposed downwards, and a lower guide portion configured to guide the cable toward the conductor for signals from one side of the lower housing; the lower guide portion is extended to a predetermined length along a length direction of the cable to accommodate a portion of the cable and is formed such that a portion of an inner circumferential surface thereof surrounds an exposed outer conductor of the cable and another portion surrounds the sheath of the cable; the upper body includes an upper housing facing the lower housing and having a hollow portion opened downwards such that the hollow portion forms a space around the upper portion of the conductor for signals, and an upper guide portion configured to guide the cable toward the conductor for signals from one side of the upper housing; the upper guide portion is extended to a predetermined length along the length direction of the cable to accommodate a portion of the cable and is formed such that a portion of an inner surface of the extended upper guide portion surrounds the exposed outer conductor of the cable and another portion surrounds the sheath of the cable; skirt portions extended downward to enclose both sides of the lower guide portion are formed on both sides of the upper guide portion, and in a state where the lower guide portion is positioned inside the upper guide portion, ends of the skirt portions formed on both sides of the upper guide portion are bent towards each other, tightening the lower guide portion, so that the cable accommodated inside the upper guide portion and the lower guide portion is clamped.

Clamping grooves may be respectively formed on lower portions of both sides of the lower guide portion to accommodate the bent ends of the skirt portions.

At least one protruding portion protruding in a radial direction may be formed on inner surfaces of the upper guide portion and the lower guide portion to clamp the cable.

### Advantageous Effects

A plug connector according to an embodiment of the present invention allows electrical and physical connection between a conductor for ground of a cable and a conductive housing of the plug connector to be achieved by clamping without the use of soldering, thereby enhancing electrical and physical stability and improving shielding performance.

Effects of the present invention are not limited to the foregoing effects, and additional effects, which are not mentioned herein, will be readily understood by those skilled in the art from the following description.

### BRIEF DESCRIPTION OF DRAWINGS

FIG. 1 is a top view of a plug connector and a receptacle connector according to an embodiment of the present invention.

FIG. 2 is a bottom view of the plug connector and the receptacle connector according to an embodiment of the present invention.

FIG. 3 is an exploded view from above of the plug connector.

FIG. 4 is an exploded view from below of the plug connector.

FIG. 5 is a cross-sectional view of a state in which the plug connector and the receptacle connector are coupled to each other.

FIGS. 6A to 6E are views illustrating a process of connecting a plug connector and a cable.

FIG. 7 is a view showing a modified embodiment of a clamp ring 180 and lower and upper clamping portions 143 and 153.

FIG. 8 is a view showing another modified embodiment of the clamp ring 180 and the lower and upper clamping portions 143 and 153.

FIG. 9 is a view showing yet another modified embodiment of the clamp ring 180 and the lower and upper clamping portions 143 and 153.

FIG. 10 is a view showing another modified embodiment of the lower and upper clamping portions 143 and 153.

FIG. 11 is a bottom view of a plug connector according to another embodiment of the present invention.

FIG. 12 is a top view of the plug connector of FIG. 11.

FIGS. 13A and 13B are front views of the plug connector of FIG. 11.

FIG. 14 is a cross-sectional view of the plug connector of FIG. 11.

### MODE FOR INVENTION

Hereinafter, exemplary embodiments of the present invention will be described in detail with reference to the drawings. In the following descriptions and accompanying drawings, like reference numerals substantially refer to like elements, and as a result, a duplicated description will be omitted. Further, in the description of the present invention, detailed descriptions of related well-known functions or configurations that are determined to unnecessarily obscure the gist of the present invention will be omitted.

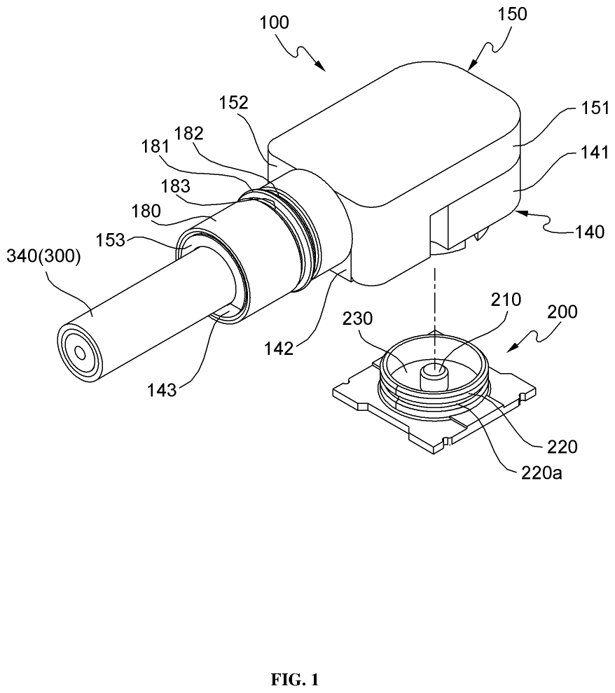

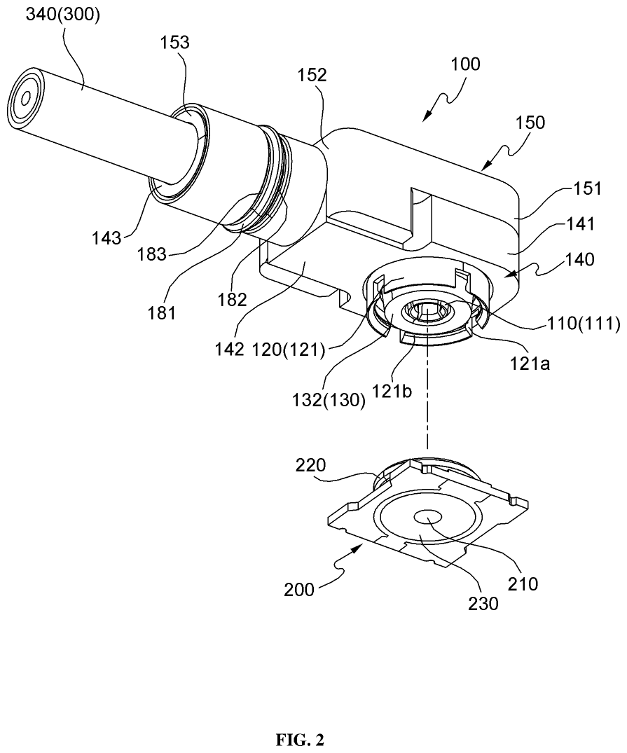

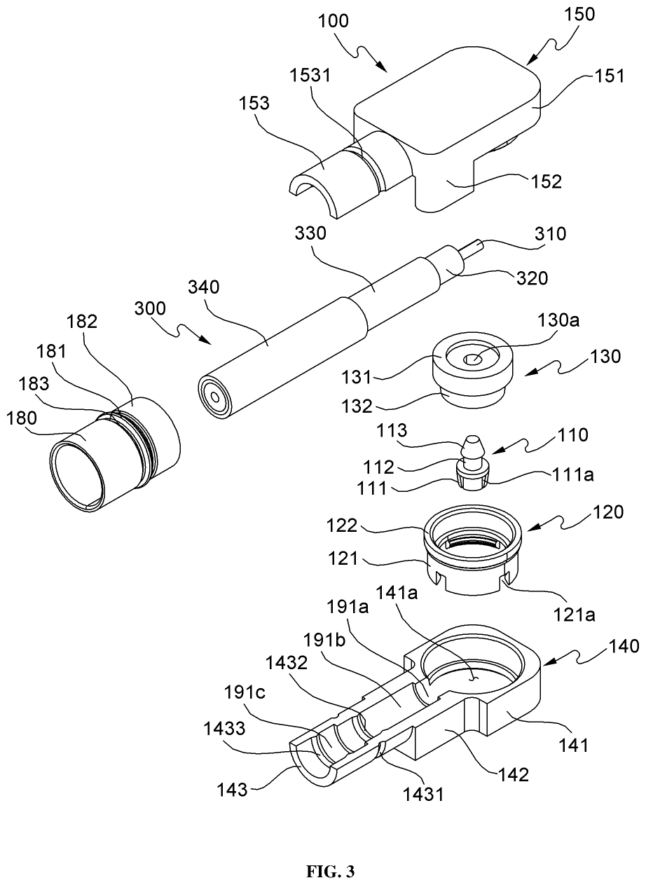

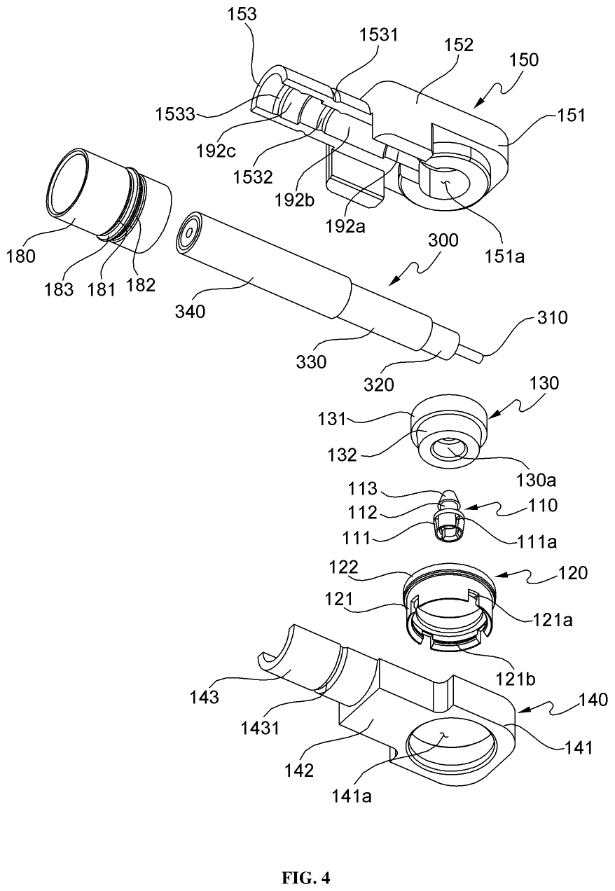

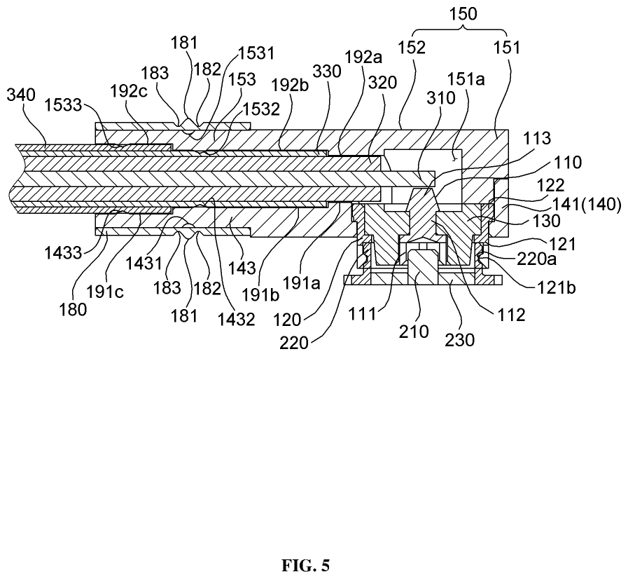

FIGS. 1 to 5 are views of a plug connector according to an embodiment of the present invention. FIG. 1 is a top view of a plug connector and a receptacle connector, FIG. 2 is a bottom view of the plug connector and the receptacle connector, FIG. 3 is an exploded view from above of the plug connector, FIG. 4 is an exploded view from below of the plug connector, and FIG. 5 is a cross-sectional view of a state in which the plug connector and the receptacle connector are coupled to each other.

A plug connector 100 according to an embodiment of the present invention is coupled to a receptacle connector 200. The receptacle connector 200 may be mounted on a circuit board in various ways. Alternatively, the receptacle connector 200 may be formed integrally with the circuit board, rather than being a separate component. The receptacle connector 200 may include a columnar conductor 210 for signals, a ring-shaped conductor 220 for ground that surrounds the conductor 210 for signals, and a ring-shaped insulator 230 that insulates between the conductor 210 for signals and the conductor 220 for ground. However, the illustrated receptacle connector 220 is merely an example, and those skilled in the art will appreciate that the plug connector 100 according to the present invention can be coupled to receptacle connectors of various shapes and structures.

The plug connector 100 according to the present embodiment may include a conductor 110 for signals, a conductor 120 for ground, an insulator 130, a lower body 140, an upper body 150, and a clamp ring.

The conductor 110 for signals is provided to make electrical contact with the conductor 210 for signals of the receptacle connector 200. The conductor 110 for signals includes a lower portion 111, a middle portion 112, and an upper portion 113. A hollow portion may be formed on the lower portion 111 of the conductor 110 for signals and the conductor 210 for signals of the receptacle connector 200 may be inserted into the hollow portion and thus make electrical contact. The lower portion 111 of the conductor 110 for signals may be formed in a tapered manner and have a cut-out groove 111a formed thereon so that the conductor 210 for signals of the receptacle connector 200 may make more stably contact with the conductor 110 for signals.

The conductor 120 for ground is provided to make electrical contact with the conductor 220 for ground of the receptacle connector 200. The conductor 120 for ground is formed in a ring shape to surround the conductor 110 for signals. The conductor 120 for ground includes a lower portion 121 and an upper portion 122. The conductor 220 for ground of the receptacle connector 200 may be inserted into the lower portion 121 so that the inner circumferential surface of the lower portion 212 may be in electrical contact with the outer circumferential surface of the conductor 220 for ground. The lower portion 121 of the conductor 120 for ground may be formed in a tapered manner and have a cut-out groove 121a so that the conductor 220 for ground of the receptacle connector 200 may make more stable contact with the conductor 120 for ground. In addition, a concave portion 220a may be formed along the outer circumference of the conductor 220 for ground of the receptacle connector 200 and a convex portion 121b may be formed along the inner circumference of the lower portion 121, so that as the convex portion 121b is engaged with the concave portion 220a, the plug connector 100 and the receptacle connector 200 can be more firmly coupled to each other.

The insulator 130 is formed in a ring shape such that it is surrounded by the conductor 120 for ground while enclosing the conductor 110 for signals to insulate between the conductor 110 for signals and the conductor 120 for ground. The insulator 130 includes a first portion 131 and a second portion 132 below the first portion 131. The lower portion 111 of the conductor 110 for signals protrudes below the first portion 131, the middle portion 112 of the conductor 110 for signals is inserted into a hollow portion 130a of the first portion 131, and the upper portion 113 of the conductor 110 for signals protrudes above the first portion 131. The lower portion 121 of the conductor 120 for ground protrudes below the first portion 131, and the upper portion 122 of the conductor 120 for ground surrounds the first portion 131. A stepped portion may be formed on the inner circumferential surface of the conductor 120 for ground so that the lower edge of the first portion 131 may be seated on the stepped portion. The second portion 132 of the insulator 130 is formed to be surrounded by the lower portion 121 of the conductor 120 for ground while surrounding the lower portion 111 of the conductor 110 for signals. Also, the second portion 132 is formed to have an outer diameter smaller than the inner diameter of the conductor 220 for ground so as to be inserted into the conductor 220 for ground of the receptacle connector 220. The second portion 132 serves to guide the conductor 110 for signals and the conductor 210 for ground of the plug connector 100 to the conductor 220 for signals and the conductor 111 for ground of the receptacle connector 200 while protecting the lower portion 110 of the conductor 120 for signals.

The lower body 140 may include a lower housing 141, a lower guide portion 142, and a lower clamping portion 143. The upper body 150 may be coupled onto the lower body 140 and may include an upper housing 151, an upper guide portion 152, and an upper clamping portion 153. The lower body 140 and the upper body 150 may be made of a conductive material. Accordingly, the lower body 140 and the upper body 150 may provide excellent shielding performance.

The cable 300 may include the signal line (internal conductor) 310, an outer conductor 330 configured to shield electromagnetic waves of the signal line 310 and made of aluminum, copper, or the like, a dielectric 330 configured to insulate and separate between the signal line 320 and the outer conductor 310, and a sheath (jacket) 340 configured to protect the outer conductor 330. The cable 300 may include a portion where the signal line 310 is exposed, a portion where the dielectric 320 is exposed, and a portion where the outer conductor 330 is exposed, in order from the end of the conductor 110 for signals.

The cable 300 may be guided toward the conductor 110 for signals through the lower and upper clamping portions 143 and 153 and the lower and upper guide portions 142 and 152, so that an end of a signal line 310 of the cable 300 can be located above the upper portion 113 of the conductor 110 for signals. In addition, the upper portion 113 of the conductor 110 for signals may be electrically coupled to the signal line 310 of the cable 300 through soldering.

The lower housing 141 has a vertically open hollow portion 141a formed therein, and the upper portion 122 of the conductor 120 for ground is accommodated in the hollow portion 141a. The lower portion 121 of the conductor 120 for ground and the lower portion 111 of the conductor 110 for signals are exposed downward through the lower housing 141. A stepped portion is formed along the inner circumference of the hollow portion 141a of the lower body 140 and a locking step is formed along the outer circumference of the upper portion 122 of the conductor 120 for ground so that the locking step can be seated on the stepped portion.

The upper housing 151 faces the lower housing 141 and has a hollow portion 151a opened downwards so that the hollow portion 151a forms a space around the upper portion 113 of the conductor 110 for signals.

The lower guide portion 142 guides the cable 300 toward the conductor 110 for signals from one side of the lower housing 141. The upper guide portion 152 faces the lower guide portion 142 and guides, together with the lower guide portion 142, the cable 300 toward the conductor 110 for signals from one side of the upper housing 151.

The lower clamping portion 143 protrudes from one side of the lower guide portion 142. A part of the lower clamping portion 143 (a part closer to the lower guide portion 142) surrounds the exposed outer conductor 330 of the cable 300, while another part of the lower clamping portion 143 (the part more distant from the lower guide portion 142) surrounds the sheath 340 of the cable 300.

The upper clamping portion 153 protrudes from one side of the upper guide portion 152 to face the lower clamping portion 143. A part of the upper clamping portion 153 (a part closer to the upper guide portion 152) surrounds the exposed outer conductor 330 of the cable 300, while another part of the lower clamping portion 153 (the part more distant from the upper guide portion 152) surrounds the sheath 340 of the cable 300.

Starting from the hollow portion 141a of the lower body 140, a first lower guide surface 191a is formed on the lower guide portion 142, a second lower guide surface 191b extends across both the lower guide portion 142 and the lower clamping portion 143, and a third lower guide surface 191c is formed on the lower clamping portion 143.

Starting from the hollow portion 151a of the upper body 150, a first upper guide surface 192a is formed on the upper guide portion 152, a second upper guide surface 192b extends across both the upper guide portion 152 and the upper clamping portion 153, and a third upper guide surface 192c is formed on the upper clamping portion 153.

The first lower guide surface 191a, the second lower guide surface 191b, and the third lower guide surface 191c face the first upper guide surface 192a, the second upper guide surface 192b, and the third upper guide surface 192c, respectively.

When the lower body 140 and the upper body 150 are coupled to each other, the first to third lower guide surfaces 191a, 192b, and 191c and the first to third upper guide surfaces 192a, 192b, and 192c form a guide tube that guides the cable 300 toward the conductor 110 for signals.

The exposed dielectric 320 of the cable 300 is seated on the first lower guide surface 191a and the first upper guide surface 192a. The inner diameter formed by the first lower guide surface 191a and the first upper guide surface 192a corresponds to the outer diameter of the exposed dielectric 320 of the cable 300.

The exposed outer conductor 330 of the cable 300 is seated on the second lower guide surface 191b and the second upper guide surface 192b. The inner diameter formed by the second lower guide surface 191b and the second upper guide surface 192b corresponds to the outer diameter of the exposed outer conductor 330 of the cable 300.

The sheath 340 of the cable 300 is seated on the third lower guide surface 191c and the third upper guide surface 192c. The inner diameter formed by the third lower guide surface 191c and the third upper guide surface 192c corresponds to the outer diameter of the sheath 340 of the cable 300.

The clamp ring 180 compresses the lower clamping portion 143 and the upper clamping portion 153, causing them to clamp the cable 300 across the exposed outer conductor 330 and the sheath 340. The inner diameter of the clamp ring 180 corresponds to the outer diameter of the engaged lower and upper clamping portions 143 and 153.

On the outer circumferential surface of the clamp ring 180, a protruding portion 181 is formed along the circumference, protruding in a radial direction, and concave portions 182 and 183 that are radially concave are formed on both sides of the protruding portion 181. In addition, a radially concave portion 1431 that overlaps the protruding portion 181 of the clamp ring 180 in a radial direction is formed along the circumference of the outer surface of the lower clamping portion 143, and a radially concave portion 1531 that overlaps the protruding portion 181 of the clamp ring 180 in a radial direction is formed along the circumference of the outer surface of the upper clamping portion 153. Thus, when a pressing jig (not shown) presses the clamp ring 180 (especially the protruding portion 181) during the coupling of the plug connector 100 and the cable 300, the protruding portion 181 is pushed outward and inward, filling the concave portions 182 and 183 on both sides thereof, as well as the concave portions 1431 and 1531 of the lower and upper clamping portions 143 and 153, resulting in a firm engagement between the clamp ring 180 and the lower and upper clamping portions 143 and 153.

On the inner circumferential surface of the lower clamping portion 143, specifically the portion (i.e., the second lower guide surface 191b of the lower clamping portion 143) that wraps around the exposed outer conductor 330 of the cable 300, a protruding portion 1432 is formed along the circumference, protruding in a radial direction. Also, on the inner circumferential surface of the upper clamping portion 153, specifically the portion (i.e., the second upper guide surface 192b of the upper clamping portion 153) that wraps around the exposed outer conductor 330 of the cable 300, a protruding portion 1532 is formed along the circumference, protruding in a radial direction. Thus, when the pressing jig presses the clamp ring 180 during the coupling of the plug connector 100 and the cable 300, the protruding portions 1432 and 1532 of the lower and upper clamping portions 143 and 153 dig into the exposed outer conductor 330 of the cable 300, resulting in a strong physical and electrical connection between the lower and upper clamping portions 143 and 153 and the exposed outer conductor 330 of the cable 300.

On the inner circumferential surface of the lower clamping portion 143, specifically the portion (i.e., the third lower guide surface 191c) that wraps around the sheath 340 of the cable 300, a protruding portion 1433 is formed along the circumference, protruding in a radial direction. Also, on the inner circumferential surface of the upper clamping portion 153, specifically the portion (i.e., the third upper guide surface 192c) that wraps around the sheath 340 of the cable 300, a protruding portion 1533 is formed along the circumference, protruding in a radial direction. Thus, when a pressing jig presses the clamp ring 180 during the coupling of the plug connector 100 and the cable 300, the protruding portions 1433 and 1533 of the lower and upper clamping portions 143 and 153 dig into the sheath 340 of the cable 300, resulting in a strong bond between the lower and upper clamping portions 143 and 153 and the sheath 340 of the cable 300.

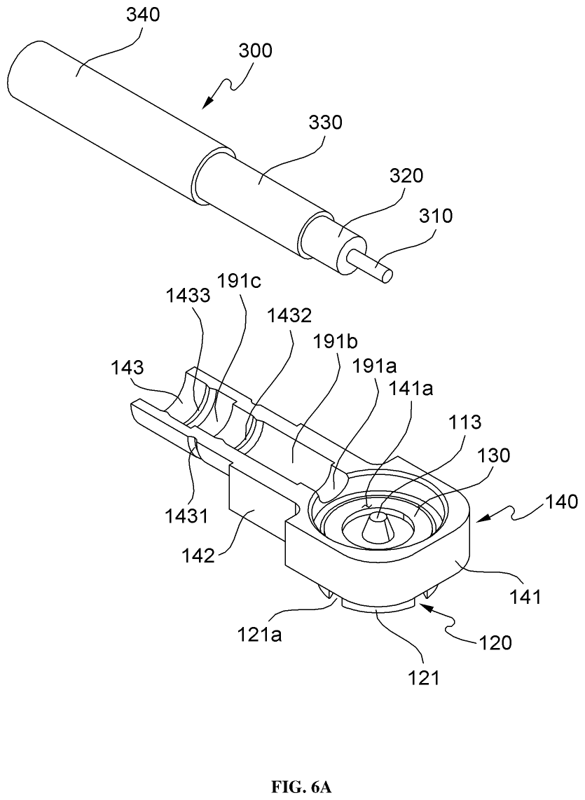

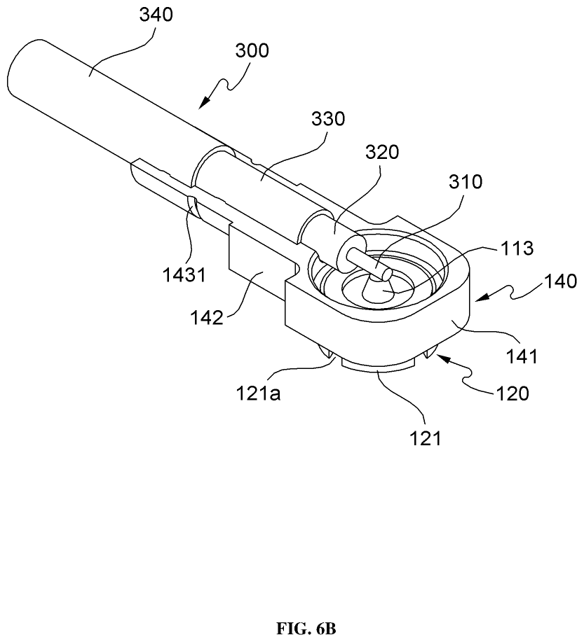

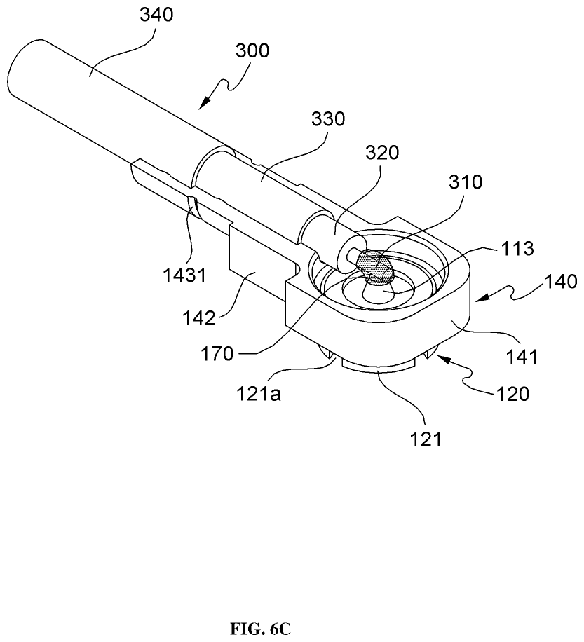

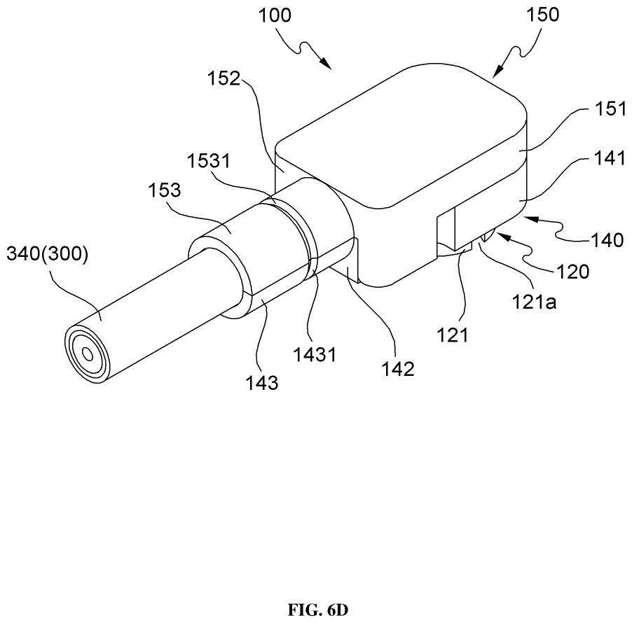

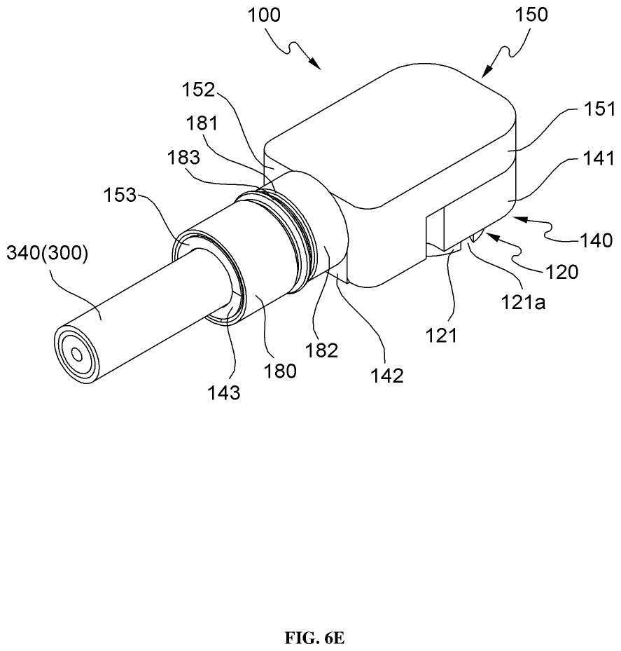

FIGS. 6A to 6E are views illustrating a process of connecting a plug connector and a cable.

Referring to FIG. 6A, a cable 140 in which a signal line 310, a dielectric 320, and an outer conductor 330 are exposed is aligned on the lower body 150, while the upper body 300 is open.

Referring to FIG. 6B, the cable 300 is seated on the first to third lower guide surfaces 191a, 192b, and 192c such that the end of the signal line 310 is located above the upper portion 113 of the conductor 110 for signals.

Referring to FIG. 6C, the exposed signal line 310 of the cable 300 and the upper portion 113 of the conductor 110 for signals are soldered to form a soldering portion 170.

Referring to FIG. 6D, the upper body 150 is coupled onto the lower body 140.

Referring to FIG. 6E, the clamp ring 180 surrounds the lower and upper clamping portions 143 and 153, and compressing the clamp ring 180 with a compression jig (not shown) enables the clamp ring 180 and the lower and upper clamping portions 143 and 153 to be engaged with each other, and at the same time causes the lower and upper clamping portions 143 and 153 to be coupled to the cable 300.

According to an embodiment of the present invention, it is possible to firmly couple the plug connector and the cable through a very simple operation as described above.

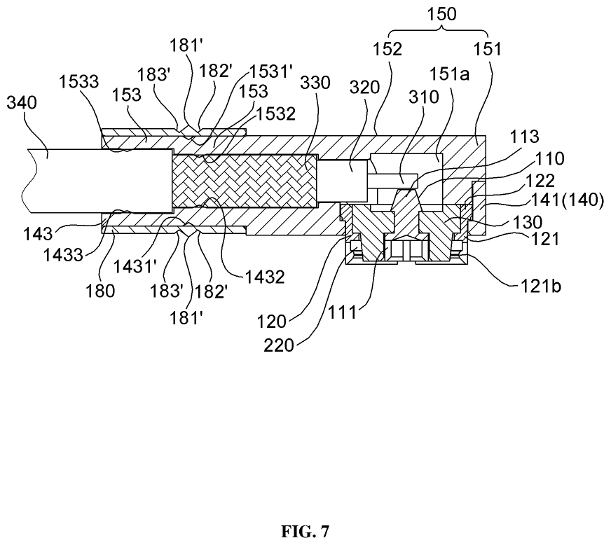

FIG. 7 is a view showing a modified embodiment of a clamp ring 180 and lower and upper clamping portions 143 and 153. As shown in FIG. 5, the protruding portion 181 and the concave portions 182 and 183 of the clamp ring 180, as well as the concave portions 1431 and 1531 of the lower and upper clamping portions 143 and 153, may be formed with a rounded cross-section. However, as shown in FIG. 7, a protruding portion 181′ and concave portions 182′ and 183′ of a clamp ring 180, as well as concave portions 1431′ and 1531′ of lower and upper clamping portions 143 and 153, may also be formed with a wedge-shaped cross-section.

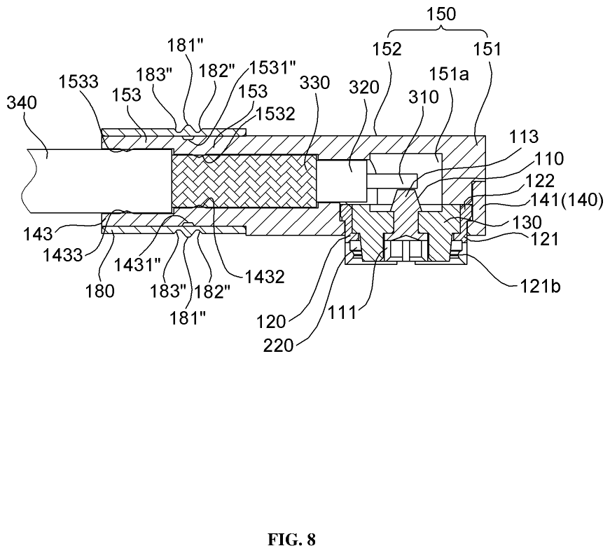

FIG. 8 is a view showing another modified embodiment of the clamp ring 180 and the lower and upper clamping portions 143 and 153. As shown in FIG. 7, a protruding portion 181″ and concave portions 182″ and 183″ of a clamp ring 180, as well as concave portions 1431″ and 1531″ of lower and upper clamping portions 143 and 153, may be formed with a wedge-shaped cross-section.

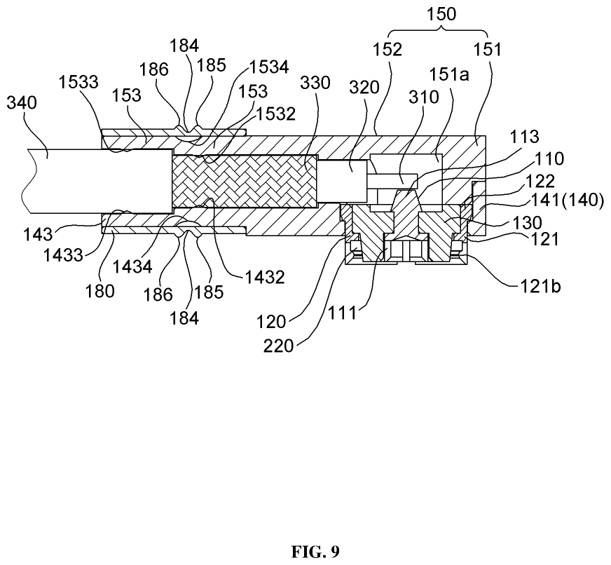

FIG. 9 is a view showing yet another modified embodiment of the clamp ring 180 and the lower and upper clamping portions 143 and 153. As shown in FIG. 9, on the outer circumferential surface of the clamp ring 180, first and second protruding portion 185 and 186 may be formed along the circumference, protruding in a radial direction, and a concave portion 184 may be formed between the first and second protruding portions 185 and 186. In addition, a radially concave portion 1434 that overlaps the first and second protruding portion 185 and 186 of the clamp ring 185 in a radial direction is formed along the circumference of the outer surface of the lower clamping portion 143, and a radially concave portion 1534 that overlaps the first and second protruding portions 185 and 186 in a radial direction is formed along the circumference of the outer surface of the upper clamping portion 153.

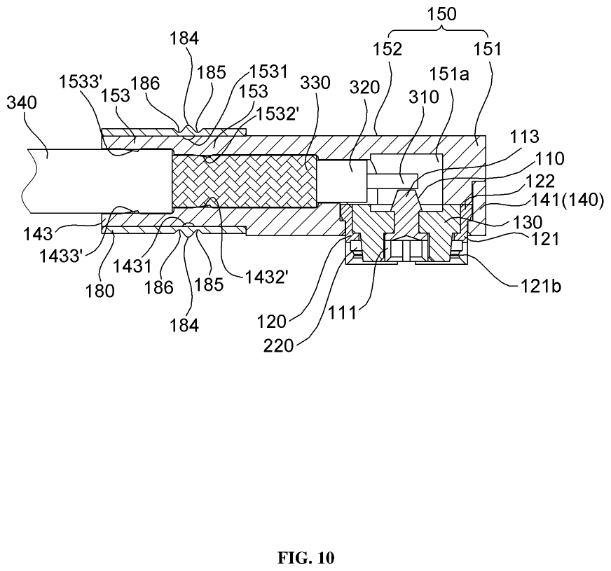

FIG. 10 is a view showing another modified embodiment of the lower and upper clamping portions 143 and 153. As shown in FIG. 5, the protruding portions 1432, 1433, 1532, and 1533 of the lower and upper clamping portions 143 and 153 may be formed with a symmetrical cross-section, but, as shown in FIG. 7, protruding portions 1432′, 1433′, 1532′, and 1533′ of lower and upper clamping portions 143 and 153 may also be formed with an asymmetric cross-section.

In the embodiments of FIGS. 1 to 10, the clamp ring 180 is used to press the lower and upper clamping portions 143 and 153 to clamp the cable 300 through the lower and upper clamping portions 143 and 153, but the present invention is not limited to such a structure.

For example, in one or more other embodiments, when the upper body 150 is coupled onto the lower body 140, as shown in FIG. 6D, the lower clamping portion 143 and the upper clamping portion 153 may be interlocked or fastened together through a method such as an interference fit or the like without using the clamp ring 180. In another embodiment, when the upper body 150 is coupled onto the lower body 140, as described in FIG. 6D, the lower clamping portion 143 and the upper clamping portion 153 may be firmly bonded to each other using an adhesive or the like, thus clamping the cable 300. In other words, any manner or structure may be applied as long as the cable 300 is clamped by the lower and upper clamping portions 143 and 153.

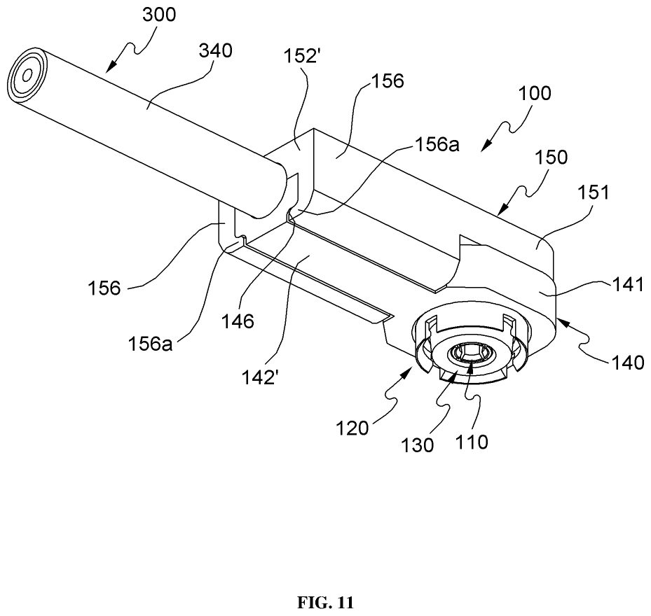

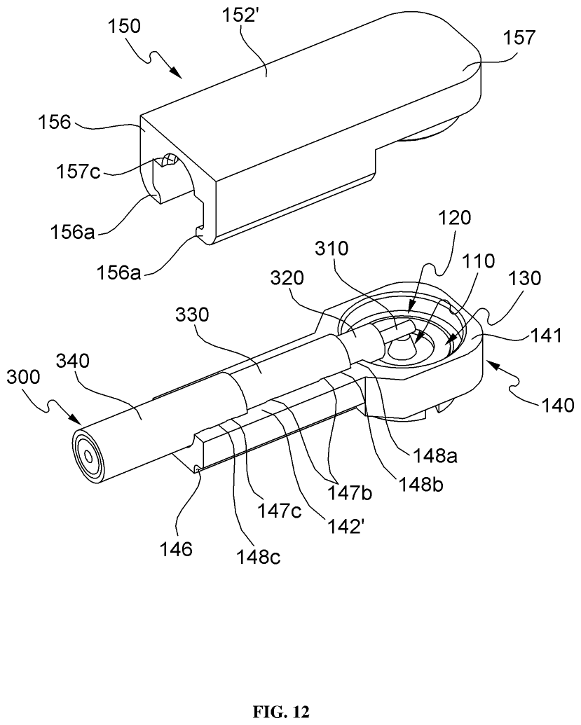

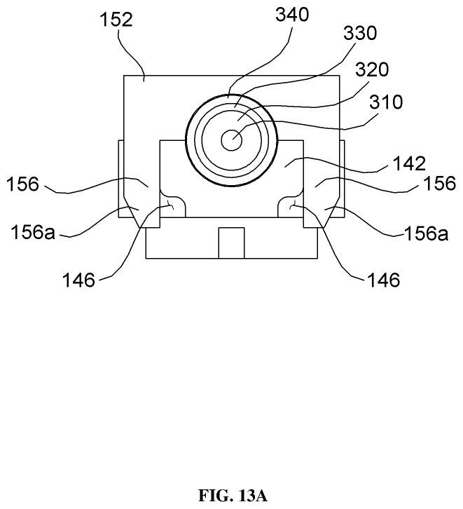

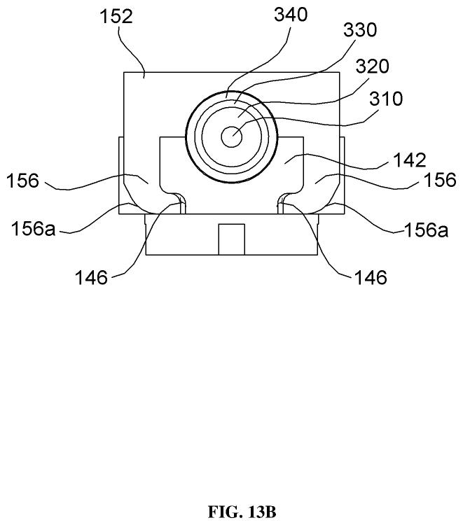

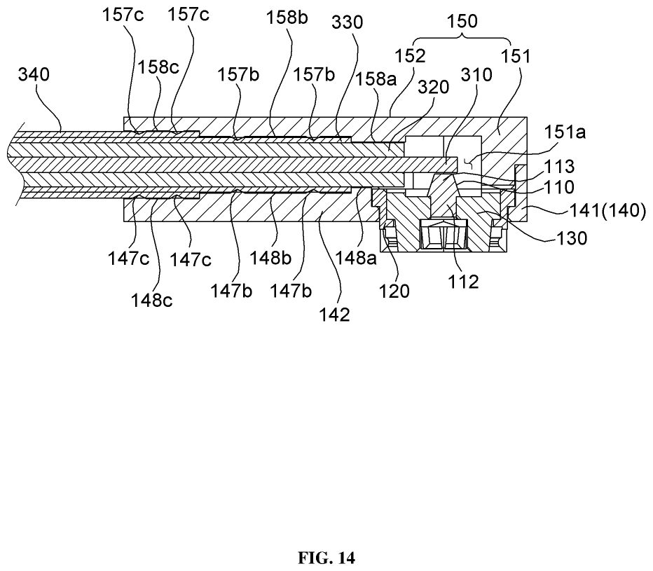

FIGS. 11 to 14 are views of a plug connector according to another embodiment of the present invention, FIG. 11 is a bottom view of the plug connector, FIG. 12 is a top view of the plug connector, FIGS. 13A and 13B are front views of the plug connector, and FIG. 14 is a cross-sectional view of the plug connector.

The embodiment of the plug connector shown in FIGS. 11 to 14 includes a conductor 110 for signals, a conductor 120 for ground, an insulator 130, a lower body 140, and an upper body 150, similarly to the embodiments of the plug connector shown in FIGS. 1 to 5. Since much of the configuration of the plug connector shown in FIGS. 11 to 14 is the same as that of the plug connector shown in FIGS. 1 to 5, the following description focuses on the differences.

In contrast to the plug connector shown in FIGS. 1 to 5, the plug connector illustrated in FIGS. 11 to 14 does not have separate upper and lower clamping portions. Instead, an upper guide portion 152′ extended from an upper housing 151 and a lower guide portion 142′ extended from a lower housing 141 substantially serve as the upper and lower clamping portions.

The upper guide portion 152′ is extended to a predetermined length to accommodate and guide a portion of the cable 300. The length of the upper guide portion 152′ may be extended to fully cover the exposed outer conductor 330 of the cable 300 and partially cover the sheath 340 of the cable. On both sides of the upper guide portion 152′, skirt portions 156 extended downward to enclose both sides of the lower guide portion 142′ are formed, allowing the lower guide portion 142′ to be positioned inside the upper guide portion 152′.

The lower guide portion 142′ is extended to a predetermined length along the length direction of the cable 300 to accommodate and guide a portion of the cable. Similar to the upper guide portion 152′, the length of the lower guide portion 142′ may be extended to fully cover the exposed outer conductor 330 of the cable 300 and partially cover the sheath 340 of the cable. Clamping grooves 146 are respectively formed at lower portions of both sides of the lower guide portion 142′ to accommodate the bent ends 156a of the skirt portions 156.

In order of proximity to the hollow portion 141a of the lower body 140, a first lower guide surface 148a, a second lower guide portion 148b, and a third lower guide surface 148c are formed on the lower guide portion 142′.

In order of proximity from the hollow 151a of the upper body 150, a first upper guide surface 158a, a second upper guide surface 158b, and a third upper guide surface 158c are formed on the upper guide portion 152′.

The first lower guide surface 148a, the second lower guide surface 148b, and the third lower guide surface 148c face the first upper guide surface 158a, the second upper guide surface 158b, and the third upper guide surface 158c, respectively.

The exposed dielectric 320 of the cable 300 is seated on the first lower guide surface 148a and the first upper guide surface 158a. The inner diameter formed by the first lower guide surface 148a and the first upper guide surface 158a corresponds to the outer diameter of the exposed dielectric 320 of the cable 300.

The entire exposed outer conductor 330 of the cable 300 is seated on the second lower guide surface 148b and the second upper guide surface 158b. The inner diameter formed by the second lower guide surface 148b and the second upper guide surface 158b corresponds to the outer diameter of the exposed outer conductor 330 of the cable 300. A protruding portion 147b radially protruding from the second lower guide surface 148b and a protruding portion 157b radially protruding from the second upper guide surface 158b are formed at positions corresponding to each other, allowing them to dig into and clamp the exposed outer conductor 330 of the cable 300 when the upper guide portion 152′ and lower guide portion 142′ are coupled. This results in a strong physical and electrical connection between the lower and upper guide portions 142′ and 152′ and the exposed outer conductor 330 of the cable 300. The second lower guide surface 148b and the second upper guide surface 158b may include a plurality of protruding portions 147b and 157b.

A portion of the sheath 340 of the cable 300 is seated on the third lower guide surface 148c and the third upper guide surface 158c. The inner diameter formed by the third lower guide surface 148c and the third upper guide surface 158c corresponds to the outer diameter of the sheath 340 of the cable 300. A protruding portion 147c radially protruding from the third lower guide surface 148c and a protruding portion 157c radially protruding from the third upper guide surface 158c are formed at positions corresponding to each other, allowing them to dig into and clamp the sheath 340 of the cable 300 when the upper guide portion 152′ and lower guide portion 142′ are coupled. The third lower guide surface 148c and the third upper guide surface 158c may include a plurality of protruding portions 147c and 157c.

FIG. 13A illustrates a state in which ends 156a of the skirt portions 156 formed on both sides of the upper guide portion 152′ are spread open, and FIG. 13B illustrates a state in which the ends 156a of the skirt portions 156 formed on both sides of the upper guide portion 152′ are bent towards each other to compress the lower guide portion 142′.

As shown in FIG. 13A, the lower guide portion 142′ may be inserted and positioned within the upper guide portion 152′ when the skirt portions 156 of the upper guide portion 152′ are in a spread open state. Subsequently, by using a predetermined tool, the ends 156a of the skirt portions are bent towards each other so that they are press-fitted into the clamping grooves 146 formed on the lower portions of both sides of the lower guide portion 142′, thereby securely fastening the lower guide portion 142′ to the upper guide portion 152′. As a result, the cable 300 accommodated within the upper guide portion 152′ and lower guide portion 142′ is clamped.

In this case, as shown in FIG. 14, the plurality of protruding portions 147b and 157b formed on the second lower and upper guide surfaces 148b and 158b of the lower and upper guide portions 142′ and 152′ dig into the exposed outer conductor 330 of the cable 300, resulting in a strong physical and electrical connection between the outer conductor 330 and the lower and upper bodies 140, 150.

Additionally, the protruding portions 147c and 157c formed on the third lower and upper guide surfaces 148c and 158c also dig into the sheath 340 of the cable 300, securely coupling the cable 300 to the lower and upper bodies 140 and 150.

A number of exemplary embodiments have been particularly shown and described with reference to certain exemplary embodiments thereof. It will be understood by one of ordinary skill in the art that various changes in form and details may be made therein without departing from the spirit and scope of the exemplary embodiments as defined by the following claims. The exemplary embodiments should be considered in a descriptive sense only and not for purposes of limitation. Therefore, the scope of the exemplary embodiments is defined not by the detailed description of the exemplary embodiments but by the following claims, and all differences within the scope will be construed as being included in the exemplary embodiments.

### INDUSTRIAL APPLICABILITY

The present invention can be efficiently applied in the field of manufacturing connectors to be connected to cables.

1. A plug connector coupled to a receptacle connector, the plug connector comprising:
a conductor for signals;
a ring-shaped conductor for ground, the conductor for ground surrounding the conductor for signals;
a ring-shaped insulator surrounding the conductor for signals and being surrounded by the conductor for ground, and insulating between the conductor for signals and the conductor for ground;
a lower body; and
an upper body coupled onto the lower body,
wherein:
the conductor for signals comprises a lower portion protruding below a first portion of the top of the insulator, a middle portion inserted into a hollow portion of the first portion, and an upper portion protruding above the first portion,
the conductor for ground comprises a lower portion protruding below the first portion and an upper portion surrounding the first portion,
the lower body comprises:
a lower housing having a hollow portion that is vertically opened, such that the upper portion of the conductor for ground is accommodated in the hollow portion and the lower portion of the conductor for ground and the lower portion of the conductor for signals are exposed downwards; and
a lower clamping portion having a part surrounding an exposed outer conductor of the cable and another part surrounding a sheath of the cable, the upper body comprises:
an upper housing facing the lower housing and having a hollow portion opened downwards such that the hollow portion forms a space around the upper portion of the conductor for signals; and
an upper clamping portion having a part surrounding the exposed outer conductor of the cable and another part surrounding the sheath of the cable, and
the cable is clamped by the lower clamping portion and the upper clamping portion.

2. The plug connector of claim 1, further comprising a clamp ring configured to compress the lower clamping portion and the upper clamping portion, enabling the lower clamping portion and the upper clamping portion to clamp the cable.

3. The plug connector of claim 1, wherein the lower body further comprises a lower guide portion configured to guide the cable toward the conductor for signals from one side of the lower housing,
the lower clamping portion protrudes from one side of the lower guide portion,
the upper body further comprises an upper guide portion facing the lower guide portion and configured to guide the cable toward the conductor for signals from one side of the upper housing, and
the upper clamping portion protrudes from one side of the upper guide portion.

4. The plug connector of claim 1, wherein the upper portion of the conductor for signals is coupled to a signal line of the cable through soldering.

5. The plug connector of claim 1, wherein an end of a signal line of the cable is located above the upper portion of the conductor for signals.

6. The plug connector of claim 2, wherein:
a protruding portion is formed along a circumference of an outer circumferential surface of the clamp ring, protruding in a radial direction,
a radially concave portion that overlaps the protruding portion in a radial direction is formed along a circumference of an outer circumferential surface of the lower clamping portion, and
a radially concave portion that overlaps the protruding portion in a radial direction may be formed along a circumference of an outer circumferential surface of the upper clamping portion.

7. The plug connector of claim 6, wherein concave portions that are radially concave are be formed on both sides of the protruding portion along the circumference of the outer circumferential surface of the clamp ring.

8. The plug connector of claim 6, wherein the protruding portion comprises first and second protruding portions and a radially concave portion is formed between the first and second protruding portions.

9. The plug connector of claim 1, wherein on an inner circumferential surface of the lower clamping portion, specifically a portion that wraps around the exposed outer conductor of the cable, a protruding portion is formed along a circumference, protruding in a radial direction, and on an inner circumferential surface of the upper clamping portion, specifically a portion that wraps around the exposed outer conductor of the cable, a protruding portion is formed along a circumference, protruding in a radial direction.

10. The plug connector of claim 1, wherein on an inner circumferential surface of the lower clamping portion, specifically a portion that wraps around the sheath of the cable, a protruding portion is formed along a circumference, protruding in a radial direction, and on an inner circumferential surface of the upper clamping portion, specifically a portion that wraps around the sheath of the cable, a protruding portion is formed along a circumference, protruding in a radial direction.

11. The plug connector of claim 1, wherein a second portion of a lower portion of the insulator is surrounded by the lower portion of the conductor for ground while surrounding the lower portion of the conductor for signals.

12. The plug connector of claim 1, wherein the lower body and the upper body are formed of a conductive material.

13. A plug connector coupled to a receptacle connector, the plug connector comprising:
a conductor for signals;
a ring-shaped conductor for ground, the conductor for ground surrounding the conductor for signals;
a ring-shaped insulator surrounding the conductor for signals and being surrounded by the conductor for ground, and insulating between the conductor for signals and the conductor for ground;
a lower body; and
an upper body coupled onto the lower body,
wherein:
the conductor for signals comprises a lower portion protruding below a first portion of the top of the insulator, a middle portion inserted into a hollow portion of the first portion, and an upper portion protruding above the first portion,
the conductor for ground comprises a lower portion protruding below the first portion and an upper portion surrounding the first portion,
the lower body comprises:
a lower housing having a hollow portion that is vertically opened, such that the upper portion of the conductor for ground is accommodated in the hollow portion and the lower portion of the conductor for ground and the lower portion of the conductor for signals are exposed downwards; and
a lower guide portion configured to guide the cable toward the conductor for signals from one side of the lower housing,
the lower guide portion is extended to a predetermined length along a length direction of the cable to accommodate a portion of the cable and is formed such that a portion of an inner circumferential surface thereof surrounds an exposed outer conductor of the cable and another portion surrounds the sheath of the cable,
the upper body comprises:
an upper housing facing the lower housing and having a hollow portion opened downwards such that the hollow portion forms a space around the upper portion of the conductor for signals; and
an upper guide portion configured to guide the cable toward the conductor for signals from one side of the upper housing,
the upper guide portion is extended to a predetermined length along the length direction of the cable to accommodate a portion of the cable and is formed such that a portion of an inner surface of the extended upper guide portion surrounds the exposed outer conductor of the cable and another portion surrounds the sheath of the cable,
skirt portions extended downward to enclose both sides of the lower guide portion are formed on both sides of the upper guide portion, and in a state where the lower guide portion is positioned inside the upper guide portion, ends of the skirt portions formed on both sides of the upper guide portion are bent towards each other, tightening the lower guide portion, so that the cable accommodated inside the upper guide portion and the lower guide portion is clamped.

14. The plug connector of claim 13, wherein clamping grooves are respectively formed on lower portions of both sides of the lower guide portion to accommodate the bent ends of the skirt portions.

15. The plug connector of claim 13, wherein at least one protruding portion protruding in a radial direction may be formed on inner surfaces of the upper guide portion and the lower guide portion to clamp the cable.

16. The plug connector of claim 13, wherein the upper portion of the conductor for signals is coupled to a signal line of the cable through soldering.

17. The plug connector of claim 13, wherein an end of a signal line of the cable is located above the upper portion of the conductor for signals.

18. The plug connector of claim 13, wherein the ends of the skirt portions are bent towards each other so that they are press-fitted into the clamping grooves.

19. The plug connector of claim 18, wherein concave portions that are radially concave are formed on both sides of the protruding portion along the circumference of the outer circumferential surface of the clamp ring.

20. The plug connector of claim 1, wherein the lower body and the upper body are formed of a conductive material.
